(19) United States
(12) Patent Application Publication
(10) Pub. No.: US 2016/0262389 A1
(43) Pub. Date: Sep. 15, 2016

(54) CO-PRODUCTS OF LIGNOCELLULOSIC BIOMASS PROCESS FOR LANDSCAPE APPLICATION

(71) Applicant: E I DU PONT DE NEMOURS AND COMPANY, Wilmington, DE (US)

(72) Inventor: PAUL JOSEPH FAGAN, Wilmington, DE (US)

(21) Appl. No.: 15/067,344

(22) Filed: Mar. 11, 2016

Related U.S. Application Data
(60) Provisional application No. 62/132,080, filed on Mar. 12, 2015.

(51) Int. Cl. A01N 43/08

(52) U.S. Cl. CPC A01N 43/08

(57) ABSTRACT

A method and composition are described that relate to a co-product from a lignocellulosic biomass fermentation. Whole stillage can be applied to a landscape either alone or with additional materials for various purposes such as supporting plant growth, weed control, erosion control, dust control, and hydroseeding. Whole stillage can be used without processing, or it can be pretreated or concentrated.

### CROSS-REFERENCE TO RELATED APPLICATIONS

This application claims the benefit of priority to U.S. Provisional Patent Application No. 62/132,080, filed on Mar. 12, 2015, which is incorporated by reference in its entirety.

### FIELD

This disclosure relates to the field of applying a co-product from a lignocellulosic biomass fermentation to a landscape. Whole stillage, which is a co-product of a lignocellulosic biomass fermentation process, provides benefits in landscape applications.

### BACKGROUND

The landscape industry is always looking for new products to enhance plant growth, control weeds, and prevent soil erosion. Thus various types of materials have been introduced into the market to address these issues.

In recent years, there has been a significant demand for application of materials from renewable resources in various end uses, and to reduce the production and applications of chemicals and materials that can be hazardous to the environment.

Lignocellulosic bio-refineries produce not only ethanol, but substantial amounts of lignocellulosic co-products from the distillation of ethanol. Such lignocellulosic co-products can find application in several end uses such as in the landscape industry, with much reduced environmental footprint.

### SUMMARY

In one aspect, the disclosure relates to a composition for landscape application comprising lignocellulosic whole stillage and at least one additive, wherein the whole stillage is a co-product of a lignocellulosic biomass fermentation process.

In another aspect, the disclosure relates to a method for treating a landscape comprising:
a) providing lignocellulosic whole stillage; and
b) applying the lignocellulosic whole stillage to the landscape;
wherein the whole stillage is a co-product of a lignocellulosic biomass fermentation process, and wherein a treated landscape is produced.

### DETAILED DESCRIPTION

Described herein are a composition and a method related to at least one co-product from a lignocellulosic biomass fermentation for various landscape applications. Whole stillage can be applied to a landscape either alone or with additional materials for various purposes. Following lignocellulosic biomass hydrolysate fermentation, for example using a biocatalyst that produces ethanol, the fermentation broth is separated into an alcohol-rich vapor stream and a water stream containing solutes and solids that is called whole stillage.

### Definitions

The following definitions and abbreviations are to be used for the interpretation of the claims and the specification.

As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but may include other elements not expressly listed or inherent to such composition, mixture, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The indefinite articles “a” and “an” preceding an element or component of the disclosure are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, the term “about” modifying the quantity of an ingredient or reactant of the disclosure employed refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities. In one embodiment, the term “about” means within 10% of the reported numerical value, preferably within 5% of the reported numerical value.

The term “fermentable sugar” refers to oligosaccharides and monosaccharides that can be used as a carbon source by a microorganism in a fermentation process.

The term “lignocellulosic” refers to a composition comprising both lignin and cellulose. Lignocellulosic material may also comprise hemicellulose.

The term “cellulosic” refers to a composition comprising cellulose and additional components, including hemicellulose.

The term “saccharification” refers to the production of fermentable sugars from polysaccharides.

The term “pretreated biomass” means biomass that has been subjected to pretreatment prior to saccharification. The pretreatment may take the form of physical, thermal or chemical means and combinations thereof.

The term “lignocellulosic biomass” refers to any lignocellulosic material and includes materials comprising cellulose, hemicellulose, lignin, starch, oligosaccharides and/or monosaccharides. Biomass can also comprise additional components, such as protein and/or lipid. Biomass can be derived from a single source, or biomass can comprise a mixture derived from more than one source; for example, biomass could comprise a mixture of corn cobs and corn stover, or a mixture of grass and leaves. Lignocellulosic biomass includes, but is not limited to, bioenergy crops, agricultural residues, municipal solid waste, industrial solid waste, sludge from paper manufacture, yard waste, wood and forestry waste. Examples of biomass include, but are not limited to, corn cobs, crop residues such as corn husks, corn stover, grasses (including Miscanthus), wheat straw, barley straw, hay, rice straw, switchgrass, waste paper, sugar cane bagasse, sorghum material, soybean plant material, components obtained from milling of grains or from using grains in production processes (such as DDGS: dried distillers grains with solubles), trees, branches, roots, leaves, wood chips, sawdust, shrubs and bushes, vegetables, fruits, flowers, empty palm fruit bunch, and energy cane.

The term “energy cane” refers to sugar cane that is bred for use in energy production. It is selected for a higher percentage of fiber than sugar. The term “lignocellulosic biomass hydrolysate” refers to the product resulting from saccharification of lignocellulosic biomass. The biomass may also be pretreated or pre-processed prior to saccharification.

The term “lignocellulosic biomass hydrolysate fermentation broth” is broth containing product resulting from biocatalyst growth and production in a medium comprising lignocellulosic biomass hydrolysate. This broth includes components of lignocellulosic biomass hydrolysate that are not consumed by the biocatalyst, as well as the biocatalyst itself and product made by the biocatalyst.

The term “slurry” refers to a mixture of insoluble material and a liquid. A slurry may also contain a high level of dissolved solids. Examples of slurries include a saccharification broth, a fermentation broth, and a stillage.

The terms “lignocellulosic filter cake” or “filter cake” refer to high lignin-content solids that results from separation of whole stillage into solids (filter cake) and liquids (thin stillage) fractions.

The terms “lignocellulosic syrup” or “syrup”, as used herein, refer to the liquid fraction of the whole stillage that is further processed by evaporation. When the water is removed from the liquid fraction, a high solids syrup is produced.

The term “soil substitute”, as used herein, refers to any material that can be used, in place of commonly used variety of soils, to provide support for the plant structure and provide the required nutrients for its growth under the desired conditions.

The term “target product” refers to any product that is produced by a microbial production host cell in a fermentation process. Target products may be the result of genetically engineered enzymatic pathways in host cells or may be produced by endogenous pathways. Typical target products include but are not limited to acids, alcohols, alkanes, alkenes, aromatics, aldehydes, ketones, biopolymers, proteins, peptides, amino acids, vitamins, antibiotics, and pharmaceuticals.

The term “fermentation” refers broadly to the use of a biocatalyst to produce a target product. Typically the biocatalyst grows in a fermentation broth utilizing a carbon source in the broth, and through its metabolism produces a target product.

“Solids” refers to soluble solids and insoluble solids. Solids from a lignocellulosic fermentation process contain residue from the lignocellulosic biomass used to make hydrolysate medium.

“Volatiles” refers herein to components that will largely be vaporized in a process where heat is introduced. Volatile content is measured herein by establishing the loss in weight resulting from heating under rigidly controlled conditions to 950° C. (as in ASTM D-3175). Typical volatiles include, but are not limited to, hydrogen, oxygen, nitrogen, acetic acid, and some carbon and sulfur.

“Fixed carbon” refers herein to a calculated percentage made by summing the percent of moisture, percent of ash, and percent of volatile matter, and then subtracting that percent from 100.

“Ash” is the weight of the residue remaining after burning under controlled conditions according to ASTM D-3174.

“Sugars” as referred to herein means a total of monosaccharide and soluble oligosaccharides.

As defined herein, “macronutrients” are any nitrogen (N), phosphorus (P), or potassium (K) containing substance which can deliver nutrition to the plant. As defined herein, “micronutrients” are substances that are required in small amounts for plant growth such as boron (B), calcium (Ca) chlorine (Cl), manganese (Mn), iron (Fe), zinc (Zn), copper (Cu), molybdenum (Mo) and selenium (Se). Hereafter, the term “nutrients” is used for both macro- and micronutrients.

As defined herein, “plant” or “plant material” is intended to refer to any part of a plant (e.g., roots, foliage, shoot) as well as seeds, trees, shrubbery, flowers, and grasses.

As defined herein, “plant amendment material” refers to material derived from plants that can be used as an amendment in a composition. Examples of plant amendment material include straws, and materials manufactured from plants such as plant fibers, cardboard, newspaper, paper, waste paper, tree bark, shredded wood, wood pulp, shredded plants, cellulose, agricultural waste (corn stover, sugar cane bagasse, etc.) or energy plant crops (switchgrass, miscanthus, arundo donax, hemp), as well as roots, foliage, trees, shrubbery, flowers, grasses, and mixtures thereof. As defined herein, the term “soil amending material” refers to sand, vermiculite, mineral clay, peat moss, gypsum, perlite, limestone, plant fibers, Turface® or mixtures thereof As defined herein, the term “plant growth”, refers to any increase of plant biomass comprising at least one of: germination of seeds, emerging of leaves on existing stems, increasing the height of the stem, increasing the width of the stem, increasing the root mass, flowering and fruit/seed production.

As defined herein, the term “tackifies” refers to an adhesive additive for landscape products that aids in holding the product together upon drying or once distributed to a landscape. Tackifiers can be plant based products, or polymeric emulsion blends. Examples of tackifiers include, but are not limited to, guar, psyllium, starch, acrylic copolymer, acrylic polymer, liquid polymer of methylacrylate, liquid polymer of acrylate, copolymer of sodium acrylate, copolymer of acrylamide, polyacrylamide, copolymer of polyacrylamide, and hydrocolloid polymer. Tackifiers can be used alone or in combination with other tackifiers or other materials.

As defined herein, the term “landscape” comprises the visible features of an area of land, including the physical elements of landforms such as mountains, hills, water bodies such as rivers, lakes, ponds and the sea and living elements of land cover including indigenous vegetation. The vast range of landscapes include, but are not limited to: the icy landscapes of polar regions, mountainous landscapes, vast arid desert landscapes, islands and coastal landscapes, densely forested or wooded landscapes including past boreal forests and tropical rainforests, and agricultural landscapes of temperate and tropical regions. Landscape can further include land adjacent to buildings, roads, and railroad tracks, decorative garden land and farm land and for soil coverage in interior or exterior plant containers.

The lignocellulosic whole stillage (“whole stillage” hereafter) suitable for application in the instant disclosure is produced as a co-product from a process that uses lignocellulosic biomass as a source of fermentable sugars which are used as a carbon source for a biocatalyst. The biocatalyst uses the sugars in a fermentation process to produce a target product.

### Fermentation of Lignocellulosic Biomass

To produce fermentable sugars from lignocellulosic biomass, the biomass is treated to release sugars such as glucose, xylose, and arabinose from the polysaccharides of the biomass. Lignocellulosic biomass may be treated by any method known by one skilled in the art to produce fermentable sugars in a hydrolysate. Typically the biomass is pretreated using physical, thermal and/or chemical treatments, and saccharified enzymatically. Thermo-chemical pretreatment methods include steam explosion or methods of swelling the biomass to release sugars (see for example WO2010113129; WO2010113130). Chemical saccharification may also be used. Physical treatments such as these may be used for particle size reduction prior to further chemical treatment. Chemical treatments include base treatment such as with strong base (ammonia or NaOH), or acid treatment (U.S. Pat. No. 8,545,633; WO2012103220). In one embodiment the biomass is treated with ammonia (U.S. Pat. No. 7,932,063; U.S. Pat. No. 7,781,191; U.S. Pat. No. 7,998,713; U.S. Pat. No. 7,915,017). These treatments release polymeric sugars from the biomass. In one embodiment pretreatment is a low ammonia pretreatment where biomass is contacted with an aqueous solution comprising ammonia to form a biomass-aqueous ammonia mixture where the ammonia concentration is sufficient to maintain alkaline pH of the biomass-aqueous ammonia mixture but is less than about 12 weight percent relative to dry weight of biomass, and where dry weight of biomass is at least about 15 weight percent solids relative to the weight of the biomass-aqueous ammonia mixture, as disclosed in the U.S. Pat. No. 7,932,063, which is herein incorporated by reference.

Saccharification, which converts polymeric sugars to monomeric sugars, may be either by enzymatic or chemical treatments. The pretreated biomass is contacted with a saccharification enzyme consortium under suitable conditions to produce fermentable sugars. Prior to saccharification, the pretreated biomass can be brought to the desired moisture content and treated to alter the pH, composition or temperature such that the enzymes of the saccharification enzyme consortium will be active. The pH can be altered through the addition of acids in solid or liquid form. Alternatively, carbon dioxide (CO₂), which can be recovered from fermentation, can be utilized to lower the pH. For example, CO₂ can be collected from a fermenter and fed into the pretreatment product headspace in the flash tank or bubbled through the pretreated biomass if adequate liquid is present while monitoring the pH, until the desired pH is achieved. The temperature is brought to a temperature that is compatible with saccharification enzyme activity, as noted below. Typically suitable conditions can include temperature from about 40° C. to about 50° C. and pH between from about 4.8 to about 5.8.

Enzymatic saccharification of cellulosic or lignocellulosic biomass typically makes use of an enzyme composition or blend to break down cellulose and/or hemicellulose and to produce a hydrolysate containing sugars such as, for example, glucose, xylose, and arabinose. Saccharification enzymes are reviewed in Lynd, L. R., et al. (Microbiol. Mol. Biol. Rev., 66:506-577, 2002). At least one enzyme is used, and typically a saccharification enzyme blend is used that includes one or more glycosidases. Glycosidases hydrolyze the ether linkages of di-, oligo-, and polysaccharides and are found in the enzyme classification EC 3.2.1.x (Enzyme Nomenclature 1992, Academic Press, San Diego, Calif. with Supplement 1 (1993), Supplement 2 (1994), Supplement 3 (1995, Supplement 4 (1997) and Supplement 5 [in Eur. J. Biochem., 223:1-5, 1994; Eur. J. Biochem., 232:1-6, 1995; Eur. J. Biochem., 237:1-5, 1996; Eur. J. Biochem., 250:1-6, 1997; and Eur. J. Biochem., 264:610-650 1999, respectively]) of the general group “hydrolases” (EC 3.). Glycosidases useful in saccharification can be categorized by the biomass components they hydrolyze. Glycosidases useful in saccharification can include cellulose-hydrolyzing glycosidases (for example, cellulases, endoglucanases, exoglucanases, cellobiohydrolases, β-glucosidases), hemicellulose-hydrolyzing glycosidases (for example, xylanases, endoxylanases, exoxylanases, β-xylosidases, arabino-xylanases, mannases, galactases, pectinases, glucuronidases), and starch-hydrolyzing glycosidases (for example, amylases, α-amylases, β-amylases, glucoamylases, α-glucosidases, isoamylases). In addition, it can be useful to add other activities to the saccharification enzyme consortium such as peptidases (EC 3.4.x.y), lipases (EC 3.1.1.x and 3.1.4.x), ligninases (EC 1.11.1.x), or feruloyl esterases (EC 3.1.1.73) to promote the release of polysaccharides from other components of the biomass. It is known in the art that microorganisms that produce polysaccharide-hydrolyzing enzymes often exhibit an activity, such as a capacity to degrade cellulose, which is catalyzed by several enzymes or a group of enzymes having different substrate specificities. Thus, a “cellulase” from a microorganism can comprise a group of enzymes, one or more or all of which can contribute to the cellulose-degrading activity. Commercial or non-commercial enzyme preparations, such as cellulase, can comprise numerous enzymes depending on the purification scheme utilized to obtain the enzyme. Many glycosyl hydrolase enzymes and compositions thereof that are useful for saccharification are disclosed in WO 2011/038019 or WO 2012/125937, incorporated herein by reference. Additional enzymes for saccharification include, for example, glycosyl hydrolases that hydrolyze the glycosidic bond between two or more carbohydrates, or between a carbohydrate and a noncarbohydrate moiety.

Saccharification enzymes can be obtained commercially. Such enzymes include, for example, Spezyme® CP cellulase, Multifect® xylanase, Accelerase® 1500, Accellerase® DUET, and Accellerase® Trio™ (Dupont™/Genencor®, Wilmington, Del.), and Novozyme-188 (Novozymes, 2880 Bagsvaerd, Denmark). In addition, saccharification enzymes can be provided as crude preparations of a cell extract or a whole cell broth. The enzymes can be produced using recombinant microorganisms that have been engineered to express one or more saccharifying enzymes. For example, an H3A protein preparation that can be used for saccharification of pretreated lignocellulosic biomass is a crude preparation of enzymes produced by a genetically engineered strain of Trichoderma reesei, which includes a combination of cellulases and hemicellulases and is described in WO 2011/038019, which is incorporated herein by reference.

Chemical saccharification treatments can be used and are known to one skilled in the art, such as treatment with mineral acids including HCl and H₂SO₄ U.S. Pat. No. 5,580,389: WO2011002660).

Sugars such as glucose, xylose and arabinose are released by saccharification of lignocellulosic biomass and these monomeric sugars provide a carbohydrate source for a biocatalyst used in a fermentation process. The sugars are present in a biomass hydrolysate that is used as fermentation medium. The fermentation medium can be composed solely of hydrolysate, or can include components additional to the hydrolysate such as sorbitol or mannitol at a final concentration of about 5 mM as described in U.S. Pat. No. 7,629,156, which is incorporated herein by reference. The biomass hydrolysate typically makes up at least about 50% of the fermentation medium. Typically about 10% of the final volume of fermentation broth is seed inoculum containing the biocatalyst.

The medium comprising hydrolysate is fermented in a fermenter, which is any vessel that holds the hydrolysate fermentation medium and at least one biocatalyst, and has valves, vents, and/or ports used in managing the fermentation process. Any biocatalyst that produces a target product utilizing glucose and preferably also xylose, either naturally or through genetic engineering, may be used for fermentation of the fermentable sugars in the biomass hydrolysate made from lignocellulosic biomass. Target products that may be produced by fermentation include, for example, acids, alcohols, alkanes, alkenes, aromatics, aldehydes, ketones, biopolymers, proteins, peptides, amino acids, vitamins, antibiotics, and pharmaceuticals. Alcohols include, but are not limited to methanol, ethanol, propanol, isopropanol, butanol, ethylene glycol, propanediol, butanediol, glycerol, erythritol, xylitol, mannitol, and sorbitol. Acids may include acetic acid, formic acid, lactic acid, propionic acid, 3-hydroxypropionic acid, butyric acid, gluconic acid, itaconic acid, citric acid, succinic acid, 3-hydroxyproprionic acid, fumaric acid, maleic acid, and levulinic acid. Amino acids may include glutamic acid, aspartic acid, methionine, lysine, glycine, arginine, threonine, phenylalanine and tyrosine. Additional target products include methane, ethylene, acetone and industrial enzymes.

The fermentation of sugars in biomass hydrolysate to target products can be carried out by one or more appropriate biocatalysts, that are able to grow in medium containing biomass hydrolysate, in single or multistep fermentations. Biocatalysts may be microorganisms selected from bacteria, filamentous fungi and yeast. Biocatalysts can be wild type microorganisms or recombinant microorganisms, and can include, for example, organisms belonging to the genera of Escherichia, Zymomonas, Saccharomyces, Candida, Pichia, Streptomyces, Bacillus, Lactobacillus, and Clostridiuma. Typical examples of biocatalysts include recombinant Escherichia coli, Zymomonas mobilis, Bacillus stearothermophilus, Saccharomyces cerevisiae, Clostridia thermocellum, Thermoanaerobacterium saccharolyticum, and Pichia stipitis. To grow well and have high product production in a lignocellulosic biomass hydrolysate fermentation broth, a biocatalyst can be selected or engineered to have higher tolerance to inhibitors present in biomass hydrolysate such as acetate. For example, the biocatalyst may produce ethanol as a target product, such as production of ethanol by Zymomonas mobilis as described in U.S. Pat. No. 8,247,208, which is incorporated herein by reference.

Fermentation is carried out with conditions appropriate for the particular biocatalyst used. Adjustments can be made for conditions such as pH, temperature, oxygen content, and mixing. Conditions for fermentation of yeast and bacterial biocatalysts are well known in the art.

In addition, saccharification and fermentation may occur at the same time in the same vessel, called simultaneous saccharification and fermentation (SSF). In addition, partial saccharification may occur prior to a period of concurrent saccharification and fermentation in a process called HSF (hybrid saccharification and fermentation).

For large scale fermentations, typically a smaller culture (seed culture) of the biocatalyst is first grown. The seed culture is added to the fermentation medium as an inoculum typically in the range from about 2% to about 20% of the final volume.

Typically fermentation by the biocatalyst produces a fermentation broth containing the target product made by the biocatalyst. For example, in an ethanol process the fermentation broth may be a beer containing from about 6% to about 10% ethanol. In addition to target product, the fermentation broth contains water, solutes, and solids from the hydrolysate medium and from biocatalyst metabolism of sugars in the hydrolysate medium. Typically the target product is isolated from the fermentation broth producing a depleted broth, which can be called whole stillage. For example, when ethanol is the product, the broth is distilled, typically using a beer column, to generate an ethanol product stream and a whole stillage. Distillation can be using any conditions known to one skilled in the art including at atmospheric or reduced pressure. The distilled ethanol is further passed through a rectification column and molecular sieve to recover an ethanol product. The target product may alternatively be removed in a later step such as from a solid or liquid fraction after separation of fermentation broth.

### Whole Stillage

Whole stillage, as used herein, refers to a cloudy liquid remaining after fermentation of lignocellulosic biomass hydrolysate and subsequent distillation of a volatile target product that can be separated from the fermentation broth by distillation such as an alcohol, for example ethanol. The whole stillage includes solids that are not readily dissolved during fermentation, soluble materials, oils, organic acids, salts, proteins, and various other components. Whole stillage can contain approximately 5-12% suspended solids (7-20% total solids). Water and other volatile components can be evaporated from whole stillage to concentrate the whole stillage and produce thick whole stillage that is a concentrated whole stillage. Thick whole stillage can have approximately 9-50% total solids Thick whole stillage is prepared from whole stillage to allow adjusting viscosity of final formulations for landscape applications.

Solids can be separated from the whole stillage using a filter press, centrifugation, or other solid separation method. These solids are called filter cake. The remaining liquid fraction containing solutes, also called thin stillage, can be passed through an evaporation train to produce a syrup containing low-volatility solutes and water vapor containing high-volatility solutes, that may be condensed and further treated to remove contaminants, then recycled. Thus, the term “thin stillage” refers to a liquid fraction resulting from solid/liquid separation of a whole stillage, fermentation broth, or product depleted fermentation broth. For the purposes of the instant disclosure, thin stillage can be combined with filter cake solids to reconstitute a whole stillage. Syrup can be recombined with filter cake solids to reconstitute a thick whole stillage.

### Pretreatment of the Whole Stillage

Untreated whole stillage or thick whole stillage contains undesirable components that can be modified or destroyed using at least one of chemical and enzymatic treatments, producing pretreated whole stillage. In one embodiment untreated stillage is treated with at least one of a chemical and an enzyme to reduce the amount of acetamide to less than 50% of the original level. In various embodiments the acetamide is reduced to less than 45%, 40%, 35%, 30%, 35%, 10%, 15%, 10%, 5%, or 1% of the original level. In various embodiments, chemicals useful for treatment of the whole stillage or thick whole stillage can be chemical oxidants, chemical reductants, chemical catalysts, organic chemicals, inorganic chemicals, bases, acids and combinations thereof. For example, ozone or bleach can be used to remove odors, or modify the contained lignin in the stillage.

Alternatively, thin stillage or syrup that is to be recombined with filter cake to reconstitute whole stillage or thick whole stillage can be treated with at least one of a chemical and an enzyme, producing pretreated thin stillage or pretreated syrup. In one embodiment untreated thin stillage or syrup is treated with at least one of a chemical and an enzyme to reduce the amount of acetamide to less than 50% of the original level. In various embodiments the acetamide is reduced to less than 45%, 40%, 35%, 30%, 35%, 10%, 15%, 10%, 5%, or 1% of the original level. In various embodiments, chemicals useful for treatment of untreated thin stillage or syrup can be chemical oxidants, chemical reductants, chemical catalysts, organic chemicals, inorganic chemicals, bases, acids and mixtures thereof. For example, ozone or bleach can be used to remove odors, or modify the contained lignin in the untreated syrup. In one embodiment untreated thin stillage or syrup is treated with sulfuric acid and heat to reduce the concentration of acetamide in the resulting pretreated syrup. The term pretreated whole stillage includes a whole stillage that is reconstituted from pretreated thin stillage or syrup and filter cake.

Enzymatic treatment of the whole stillage or thick whole stillage can be performed by adding enzymes to destroy or modify some of its undesirable components.

In one embodiment untreated whole stillage, thin stillage, or syrup is treated with sulfuric acid or is treated with calcium oxide or sodium hydroxide and heat to reduce the concentration of acetamide in the resulting pretreated whole stillage. In embodiments, the pH of the whole stillage, thin stillage, or syrup is lowered to less than pH 4 or less than pH 3 or less than pH 2.5. In embodiments, the pH is raised to greater than pH 10, greater than pH 11, or greater than pH 11.5. In embodiments, the whole stillage, thin stillage, or syrup with altered pH is then heated to a temperature of at least about 90° C., at least about 95° C., or at least about 100° C. for a time sufficient to reduce the amount of acetamide.

Enzymatic treatment of untreated whole stillage, thin stillage, or syrup can be performed by adding enzymes to untreated whole stillage, thin stillage, or syrup to destroy or modify some of its undesirable components. An enzyme which reduces the amount of acetamide in a composition provided herein may be referred to as an acetamide treatment enzyme. Enzymes which may be employed for enzymatic treatment may include enzymes from a variety of sources, for example, enzymes from bacterial or fungal microorganisms. Enzymes which may be employed for enzymatic treatment may include amidases from bacterial or fungal microorganisms such as Pseudomonas, Emericella, Bacillus, Brevibacterium, Aspergillus, Saccharomyces, or Geomicrobium. Microbial amidases from Pseudomonas bacterium are available in the art and/or commercially. Examples include amidases from Pseudomonas aeruginosa (Sigma-Aldrich, St. Louis, Mo., #A6691; Andrade, et al, 2007, JBC, 282 (27): 19598-19605; Shanker, et al., 1990, Arch. Microbiol. 154: 192-198). Amidase from Emericella nidulans (Mybiosource.com, San Diego, Calif., #MBS1150173) is also commercially available. Enzymes may include one or more other amidases known in the art such as those from Bacillus sterothermophilus BR388 (Cheong, et al., 2000, Enzyme and Microbial Technol., 26:152-158), Brevibacterium sp. strain R312 (Mayaux, et al., 1990, J. Bacteriol. p.6764-6773), Bacillus sp. BR443 (Kim and Oriel, 2000, Enzyme and Microbial Technol. P.492-501), Aspergillus nidulans (U.S. Pat. No. 6,548,285; Genbank Accession No. HM015509.1), Aspergillus oryzae (U.S. Pat. No. 6,548,285), Aspergillus niger (EP0758020), Saccharomyces cerevisiae (U.S. at. No. 6,548,285), or Geomicrobium sp. JCM 19037 (Genbank Accession No. GAK00267). An amidase which reduces the amount of acetamide in a composition provided herein may be referred to as an acetamidase. In embodiments, an acetamide treatment enzyme may be a urease. In some embodiments, the urease is not urease from Canavlia ensiformis (jack bean; Sigma-Aldrich, #U1500).

Accordingly, the pretreated whole stillage, thin stillage, or syrup may comprise a reduced amount of acetamide as compared to the amount of acetamide in the untreated whole stillage, thin stillage, or syrup and as such, resulting pretreated whole stillage or pretreated thick whole stillage may be more suitable for application in the instant disclosure.

### Additives

According to the instant disclosure, the whole stillage or thick whole stillage, either of which is untreated or pretreated, can be used alone as a landscape application composition. The landscape application composition provides a benefit to the landscape including, but not limited to, support and growth for desired plant material, weed control, land erosion control, and dust control. In addition, the whole stillage or thick whole stillage can be supplemented with various types of additives that enhance the landscape application composition properties.

In one embodiment additives are those that improve support and growth of plant material. This type of additive may include soil, one or more soil amending material (including soil conditioning material), fertilizing material, plant nutrients, and the like.

A soil amending material is a substance that when applied to soil, improves the properties of the soil such that plant growth and/or yield are increased. Soil properties that can be improved include, but are not limited to, pH, drainage, providing plant nutrients, soil structure, permeabililty, water infiltration, aeration, cation exchange capacity, and water retention. Any soil amending material that is mixable may be used in the present invention. Typically the soil amending material used is a material that is particulate, and is powdery, dusty, or granular. Some examples of soil amending materials include, but are not limited to, peat moss, wood chips, grass clippings, straw, compost, manure, biosolids, plant fibers, sawdust, wood ash, vermiculite, perlite, lime (also limestone), gypsum, clay, clay minerals, bone meal, tire chunks, pea gravel, and sand. Any of these materials may be processed to a mixable form for inclusion in the present plant growth vehicle. The soil amending materials can be used alone or in various combinations and mixtures.

Additional materials that can function as fertilizers can be added to the whole stillage to help plant growth. Examples of fertilizing materials that can be used in the instant disclosure, include but are not limited to: vegetable waste and bio-degradable waste provided by natural bacteria, fungus and mechanical means and optionally mixed with cattle-dung, animal skin, poultry farm manure, pressed mud of sugar mills, sericulture waste, coconut fibers, bone powder and volcanic rock granulized by various bacterial cultures such as Azotobacter and Rhizobium and combinations thereof. Further, crop active chemicals such as pesticides, fungicides, herbicides, and the like, can be added to the whole stillage singly or in any combination as additives.

A plant amendment material may be included the present landscape application composition. These materials derived from plants are, for example, straws, and materials manufactured from plants such as plant fibers, cardboard, newspaper, paper, waste paper, tree bark, shredded wood, wood pulp, shredded plants, cellulose, agricultural waste (corn stover, sugar cane bagasse, etc.) or energy plant crops (switchgrass, miscanthus, arundo donax, hemp), as well as roots, foliage, trees, shrubbery, flowers, grasses, and mixtures thereof. These materials may be included to alter properties of a landscape application composition such as to dilute components of the whole stillage, provide mechanical support, increase volume, increase or decrease density, increase bulk, and the like. At least one of these materials may be included in present landscape application composition for use in weed control, land erosion control, and/or dust control. For example, the present landscape application composition may be applied on burned wilderness areas after a fire.

Plant seed may be included in the present landscape application composition for hydroseeding application. A tackifier may be included in the present landscape application composition. This type of additive provides adhesion and is useful, for example, in a landscape application composition for hydroseeding, weed control, mulching, or erosion or dust control.

The above-mentioned materials and any other additional chemicals or materials suitable for including with the whole stillage, to enhance landscape application properties, are called an “additive”, or “additives”.

The nature of one or more additives to be included with the whole stillage in a landscape application material can be determined based on the desired function of the landscape application material. For example, for providing support for growth of plant materials, the needs of the particular crops or flowers at the time of application to the soil are determined and additives included to meet those needs.

### Plant Nutrients

One or more plant nutrient may be an additive that is included in the present landscape application composition. Plant nutrients comprise macro- and micronutrients. As defined herein, primary macronutrients are nitrogen (N), phosphorous (P), and potassium (K). The macronutrients are important for plant growth and are used by plants in relatively large amounts in any combinations and proportions deemed suitable for each individual plant type, however, they are not always adequately available in natural soils to support the sustained growth of plants. Additionally, production of crops removes these vital macronutrients from the soil. Key macronutrients, such as nitrogen, which is essential to plant growth, will be readily removed from the soil by the production of crops.

Nitrogen for plants is provided primarily from urea, and to a lesser extent by the ammonium ion of the ammonium nitrate component. Nitrogen is vital for the formation of all new plant protoplasm. Chlorophyll is a nitrogen compound, and nitrogen is also heavily used by plants in forming stems and leaves. Blood, bone, or soybean meal or the dried residue of a manure or compost tea can also be used as substitute organic sources of nitrogen. Other nitrogen sources can include methylol urea, isobutylene urea or ammonia.

Phosphorus is provided largely by calcium phosphate and diammonium phosphate. Plants require phosphorus for photosynthesis, energy transfers within plants, and for good flower and fruit growth. Powdered bone meal, phosphate rock, and phosphoric acid can also be used as sources of phosphorus. Potassium is provided largely by muriate of potash, and to a much lesser extent by seaweed. Potassium is used by plants in the manufacture and movement of sugars and in cell division. It is necessary for root development and helps plants to retain water. Other possible sources of phosphorus would be wood ashes, granite dust, potassium chloride, potassium nitrate, potassium sulfate, and potassium carbonate.

Micronutrients (also known as trace elements) suitable for plant growth in the instant process include, but are not limited to; calcium, magnesium, iron, manganese, sulfur, molybdenum, iodine, silicon, zinc, copper, boron, and combinations thereof. These micronutrients can be added either together with macronutrients or separately to the whole stillage for supporting growth of the plant.

Any of the nutrients listed above, can be used alone or in combination with other nutrients and/or chemicals when preparing plant nutrients. The formulation and the ratio of the macro- and micronutrients in any given preparation are dictated by the specific plant's requirements.

### Landscape treatment

The whole stillage and at least one additive, as described above, are combined in a landscape application composition. In some embodiments the whole stillage is at least one of a concentrated whole stillage and a pretreated whole stillage. The additive is typically size-reduced to a mixable form if necessary, such as by chopping, shredding, grinding, and the like. The components of the composition are contacted using any mixing method such as by mixing, blending, stirring, shaking, pouring, dumping together or using an agitator such as a Vortex® mixer or paddle mixer. The resulting landscape application composition is typically a slurry of solids in liquid. In one embodiment the whole stillage and any included additives provide up to 60 mass % dry solid content of the landscape application composition. The remainder of the composition is water containing water soluble components. The whole stillage can provide about 7 to 60 mass % dry solid content. Plant amending material can provide about 0 to 52 mass % dry solid content. Soil amending material can provide about 0 to 52 mass % dry solid content. Percentages of other additives may vary depending on the additive and the desired effect of the landscape application composition.

A landscape is treated with whole stillage, which may be at least one of a concentrated whole stillage and a pretreated whole stillage and which may be contacted with at least one additive, by applying it to the landscape. Applying may be by any method such as by spraying, raking, spreading, tilling, dropping, and the like. The resulting treated landscape is provided at least one benefit which may include, but is not limited to, support for plant growth, weed control, erosion control, dust control, and hydroseeding.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### Abbreviations

The meaning of abbreviations used is as follows: “s” is second, “min” means minute(s), “h” or “hr” means hour(s), “μL” or “μl” means microliter(s), “mL” or “ml” means milliliter(s), “L” or “I” means liter(s), “m” is meter, “nm” means nanometer(s), “mm” means millimeter(s), “cm” means centimeter(s), “μm” means micrometer(s), “mM” means millimolar, “M” means molar, “mmol” means millimole(s), “μmole” means micromole(s), “g” means gram(s), “μg” means microgram(s), “mg” means milligram(s), “kg” is kilogram, “rpm” means revolutions per minute, “C” is Centigrade, “ppm” means parts per million, “cP” is centipoise, “g/l” means grams per liter, “SSU” is Saybolt Universal Viscosity in Seconds, “μE/m²” is microeinsteins per square meter.

### Analytical Method

Samples were analyzed for acetamide concentration by gas chromatography on an Agilent Technologies HP 6890 Gas Chromatograph system equipped with an auto-sampler and a flame ionization detector. The gas chomatographic column used was an Agilent Technologies J&W DB-FFAP (30 m×250 μm ID×0.25 μm nominal thickness column). Sulfolane was used as an external reference. One microliter of sample was injected with a split ratio of 75.0:1 and a flow of 102 mL/min of helium at an injection port temperature of 225° C. The oven containing the column was heated from 80° C. to 250° C. at a rate of 15° C./min and then held at 250° C. for 3 min. The flame ionization detector was set at 250° C. with a hydrogen flow of 35 mL/min and an air flow of 350 mL/min.

### Example 1

### Prophetic

### Using Whole Stillage to Control Weed During Plant Growth in Pot

Whole stillage obtained as a co-product from a lignocellulosic biomass fermentation process is concentrated to about 25 mass % dry solids by distillation of water and volatiles. Shredded newspaper is then added to the whole stillage until desired consistency for the mixture is achieved. This mixture is then added to a plant that has been potted in a potting soil. Seeds of weed plants are also added to the potting soil. A control experiment is also set up with potting soil, the same plant seeds and added weed plant seeds without application of the whole stillage and shredded newspaper. The pot containing the whole stillage and shredded newspaper controls weed growth and thus contains far less weeds compared to the control pot where no material was applied.

### Example 2

### Chemical Treatment of Syrup (Sulfuric Acid)

Lignocellulosic syrup (1.0179 g) which had a concentration of acetamide of 1.83 weight percent was mixed with 4.9545 g of deionized water in a 20 mL vial equipped with a Teflon®-coated magnetic stirring bar to produce a diluted lignocellulosic syrup with a concentration of acetamide of 0.339 weight percent. Concentrated sulfuric acid (98%, 0.0770 g) was added to lower the pH of the solution to 2.05. The vial was sealed and heated at 100° C. for 22 h with stirring.

After analysis, it was determined that the diluted lignocellulosic syrup contained 0.039 weight percent of acetamide.

### Example 3

### Treatment of Syrup at High PH (Calcium Oxide)

Lignocellulosic syrup (1.0220 g) which had a concentration of acetamide of 1.83 weight percent was mixed with 4.9527 g of deionized water in a 20 mL vial equipped with a Teflon®-coated magnetic stirring bar to produce a diluted lignocellulosic syrup with a concentration of acetamide of 0.378 weight percent. Calcium oxide (0.1329 g) was added to raise the pH of the solution to 11.97. The vial was heated at 100° C. and stirred for 22 h. It was determined that the diluted lignocellulosic syrup contained 0.121 weight percent acetamide.

### Example 4

### Treatment of Syrup at High PH (Sodium Hydroxide)

Lignocellulosic syrup (1.0214 g) which had a concentration of acetamide of 1.83 weight percent was mixed with 4.9497 g of deionized water in a 20 mL vial equipped with a Teflon®-coated magnetic stirring bar to produce a diluted lignocellulosic syrup with a concentration of acetamide of 0.378 weight percent. Sodium hydroxide (0.1094 g) was added to raise the pH of the solution to 11.95.

The vial was heated at 100° C. and stirred for 22 h. It was determined that the diluted lignocellulosic syrup contained 0.178 weight percent acetamide.

### Example 5

### Enzymatic Treatment of Syrup with Jack Bean Urease

Lignocellulosic syrup (2.4026 g, 2.3895 g, 2.3513 g, 2.3175 g) which had a concentration of acetamide of 1.83 weight percent was added to four separate 4 mL vials each equipped with a Teflon®-coated magnetic stirring bar. Approximately the same amount of Urease (obtained from Sigma-Aldrich Co., St. Louis, Mo., Catalog Number U1500, Type III, powder, 15,000-50,000 units/g solid) was added to each vial (2.4 mg, 2.6 mg, 3.0 mg, respectively). No urease was added to the fourth vial (control). The vials were stirred at room temperature. After 2 h, 7 h, and 24 h, each of the vials was removed from the magnetic stirrer, and sampled. At the end of each time period, all of the vials had a concentration of acetamide of 1.83 weight percent.

1. A composition for landscape application comprising lignocellulosic whole stillage and at least one additive, wherein the whole stillage is a co-product of a lignocellulosic biomass fermentation process.

2. The composition of claim 1, wherein the whole stillage is thick whole stillage.

3. The composition of claim 1, wherein the lignocellulosic whole stillage is pretreated whole stillage.

4. The composition of claim 3, wherein the pretreated whole stillage has been treated with either at least one chemical or at least one enzyme.

5. The composition of claim 4 wherein the chemical is selected from the group consisting of chemical oxidant, chemical reductant, chemical catalyst, organic chemical, inorganic chemical, base, acid, and combinations thereof.

6. The composition of claim 1 wherein the additive is selected from the group consisting of at least one tackifier, at least one plant nutrient, at least one plant amendment material, at least one soil amending material, at least one fertilizing material, at least one crop active chemical, plant seed, and any combination thereof.

7. The composition of claim 6, wherein the tackifier is at least one of a plant based product and a polymeric emulsion blend.

8. The composition of claim 7, wherein the tackifier is selected from the group consisting of guar, psyllium, starch, acrylic copolymer, acrylic polymer, liquid polymer of methylacrylate, liquid polymer of acrylate, copolymer of sodium acrylate, copolymer of acrylamide, polyacrylamide, copolymer of polyacrylamide, and hydrocolloid polymer.

9. The composition of claim 6, wherein the at least one plant amendment material is selected from the group consisting of roots, foliage, trees, shrubbery, flowers, grasses, straws, materials manufactured from plants such as plant fibers, cardboard, newspaper, paper, waste paper, tree bark, shredded wood, wood pulp, shredded plants, cellulose, agricultural waste such as corn stover, sugar cane bagasse, energy plant crops such as switchgrass, miscanthus, arundo donax, hemp, and mixtures thereof.

10. The composition of claim 6, wherein the plant seed is grass seed.

11. A method for treating a landscape comprising:
a) providing lignocellulosic whole stillage; and
b) applying the lignocellulosic whole stillage to the landscape;
wherein the whole stillage is a co-product of a lignocellulosic biomass fermentation process, and wherein a treated landscape is produced.

12. The method of claim 11, wherein the whole stillage is at least one of a concentrated whole stillage and a pretreated whole stillage.

13. The method of claim 12, wherein the pretreated whole stillage has been treated with either at least one chemical or at least one enzyme.

14. The method of claim 11, further comprising contacting the whole stillage of (a) with at least one additive to produce a landscape application composition.

15. The method of claim 14, wherein the additive is selected from the group consisting of at least one tackifier, at least one plant nutrient, at least one plant amendment material, at least one soil amending material, at least one fertilizing material, at least one crop active chemical, plant seed, and any combination thereof.

16. The method of claim 11, wherein the treated landscape is provided with at least one of:
a) support for plant growth;
b) weed control;
c) erosion control;
d) dust control; and
e) hydroseeding.
